(19) United States
(12) Patent Application Publication
(10) Pub. No.: US 2008/0208816 A1
(43) Pub. Date: Aug. 28, 2008

(54) Data Processing Method and System

(75) Inventors: David A. Eves, Crawley (GB); Richard S. Cole, Redhill (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/917,158

(22) PCT Filed: Jun. 13, 2006
(86) PCT No.: PCT/IB2006/051877

§ 371 Date: Dec. 11, 2007

(30) Foreign Application Priority Data
Jun. 14, 2005 (EP) 05105189.4

(51) Int. Cl. G06F 7/06; G06F 17/30

(52) U.S. Cl. 707/3; 707/E17.014

(57) ABSTRACT

A data processing method comprises receiving an electronic document, rendering at least a portion of the electronic document, detecting the portion of the electronic document that is unrendered, generating a feedback document comprising a portion of the electronic document, and transmitting the feedback document. Preferably, the feedback document comprises the portion of the electronic document that is rendered.

This invention relates to a data processing method and system, and to a computer program product, on a computer readable medium, for controlling a data processing system.

It is common in many networks, such as the Internet, to transmit data using a markup language such as HTML (Hyper Text Markup Language). The receiving computer (typically running a browser) will in general do the best they can to take the original ‘mark up’ description and reproduce the HTML as the author intended. In very controlled situations such as web browsers on Windows PCs the result is quite close to the intention and certainly easily reproducible and testable.

However in some situations the result is less certain. For example, if the HTML that is transmitted specifies a certain colour at a certain point in a piece of text, then, if the receiving device is rendering the text on a black and white monitor, it cannot carry out the original author's desire. How the receiving device handles the text that should be in colour will depend upon the way that the receiving device is configured. The text may be highlighted in a non-colour dependent fashion, or the text may be rendered as if it were the normal colour. In general, the receiving device will use the functionality of the rendering devices as best it can. The original author, or the device that provided the HTML document have no way of knowing what has actually occurred at the receiving end of the network.

In more complicated situations, the result of a browser rendering a markup language document is usually not a perfect rendering of the original author's intention. This is often because the hosting system lacks some capabilities to reproduce the described experience. This is particularly true in highly dynamic and modular systems.

United States Patent Application Publication US 2004/0267900 discloses methods and apparatus for dynamic content customization provided to clients. When a profile repository is used to store profiles indicating typical device characteristics for various clients, the repository is configured to allow a stored profile to be flagged to indicate a client is capable of being queried for dynamically determined changes and/or additions to its stored profile. Communication between content providers, e.g., one or more servers, and the client may be configured so a minimum number of notifications need be made by the client to the servers to indicate the client can be queried for specific dynamic characteristics or deviations from a default profile (if any).

This methodology effectively allows a sending device to access a profile on a receiving device that includes the capabilities of the receiving device. This allows the transmitted data to be tailored to the capabilities of the receiving device. While this is an improvement on the known systems that simply send documents etc. to be rendered as best able by the receiving device, it has a number of weaknesses and is highly unsuitable for a network such as the Internet. The system disclosed in this patent application Publication requires a constant querying of the capabilities of the device where data is to be sent. The data must be tailored to the receiving device prior to sending. This places a disproportionate load on the sending device and in many situations would lead to either a very high processing cost on the sending side or a relatively reduced response time when sending documents.

It is therefore an object of the invention to improve upon the known art.

According to a first aspect of the present invention, there is provided a data processing method comprising receiving an electronic document, rendering at least a portion of the electronic document, detecting the portion of the electronic document that is unrendered, generating a feedback document comprising a portion of the electronic document, and transmitting the feedback document.

According to a second aspect of the present invention, there is provided a data processing system comprising a receiving device for receiving an electronic document, a set of devices arranged to render at least a portion of the electronic document, the receiving device arranged to detect the portion of the electronic document that is unrendered, to generate a feedback document comprising a portion of the electronic document, and to transmit the feedback document.

According to a third aspect of the present invention, there is provided a computer program product, on a computer readable medium, for operating a data processing system comprising instructions for receiving an electronic document, rendering at least a portion of the electronic document, detecting the portion of the electronic document that is unrendered, generating a feedback document comprising a portion of the electronic document, and transmitting the feedback document.

Owing to the invention, it is possible to provide a feedback document that includes information on the extent to which the received document has been successfully rendered. In this case it would be extremely useful for the source application or author to be aware of what the end user is actually experiencing and allow the content to adapt or interaction to be modified. The original application or author that generated the markup representation would benefit from feedback of the resulting user experience.

This generation of a markup representation of what is finally rendered that may be queried by the source application or author. This approach is particularly advantageous in a dynamic markup language such as used by a system where the source application(s) may be able to adapt its behaviour due to the resultant knowledge of the end users experience. In a dynamic system the creation of the final markup terms for rendering is more fluid than in a static document. Reference to dynamic variables such as time and context will determine the exact content of the electronic document and of the individual elements within the document.

In addition this approach will give real advantages in authoring and debugging experiences, providing feedback in a form that is meaningful to the tools and author. Authoring tools also need feedback on whether the end result they are producing matches intentions. Being able to see the experience generated in the same terms as the original content will allow for faster debugging.

Advantageously, the data processing method further comprising detecting the source of the electronic document, and transmitting the feedback document to the source of the electronic document. By noting the source of the document being rendered, the feedback document can be efficiently sent to the original source for handling by the sending device or the original author of the electronic document.

Preferably, the feedback document comprises the portion of the electronic document that is rendered. By creating the feedback document to contain those elements that have been successfully rendered, the sending device or the original author can access the experience of the receiving device with respect to the original document that was transmitted.

In an alternative embodiment, the step of transmitting the feedback document comprises storing the feedback document in a local data storage device. Rather than sending back the feedback document to the transmitting device, the feedback document can be stored locally, for accessing at a later date, to interpret the results of the rendering experience of the receiving device.

Ideally, the step of rendering at least a portion of the electronic document includes selecting elements from the electronic document according to a dynamic variable. The dynamic variable may be, for example, time, which can be based upon a system clock or an arbitrary start time. Elements are selected for rendering according to whether their specified time component matches that of the running time. In such a dynamic system some elements will therefore not be rendered because they are outside the parameters of the dynamic variables being used to select elements.

Embodiments of the present invention will now be described, by way of example only, with reference to the accompanying drawings, in which:—

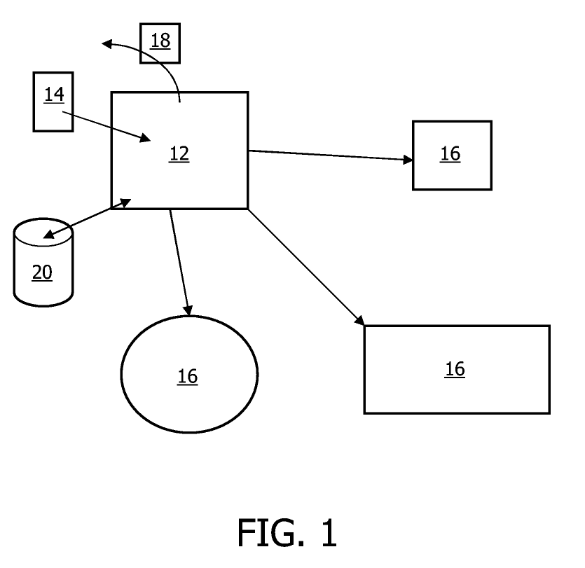

FIG. 1 is a schematic diagram of a data processing system,

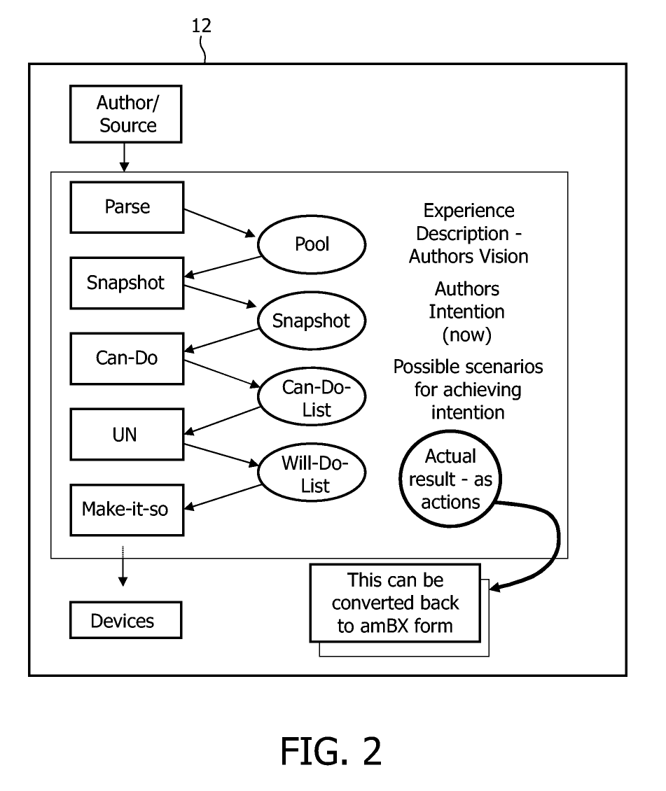

FIG. 2 is a flow diagram of the operation of a receiving device of the data processing system of FIG. 1, and

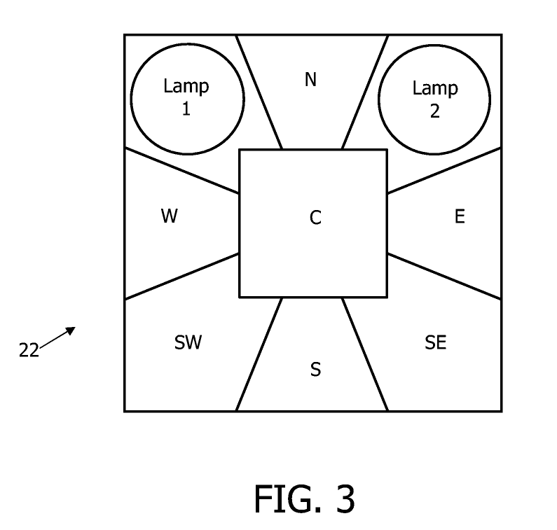

FIG. 3 is a schematic plan view of a location.

The data processing system 10 of FIG. 1 comprises a receiving device 12 for receiving an electronic document 14 such as an HTML document or a document designed using a different XML compliant language. The system also includes a set of devices 16 arranged to render at least a portion of the electronic document 14. The receiving device 12, which could be a standard desktop PC or a media device such as a digital television, can form part of the set of devices that will render the electronic document 14.

The devices 16 in the set of devices can constitute devices such as display devices, lighting devices etc. and may be electronic, but also could be mechanical devices such as fans or heaters etc. For more detail about such systems, the contents of WO 02/092183 are hereby incorporated by reference. Essentially, the devices 16 in the set render the information in the electronic document to provide the ambient environment in a location.

The receiving device 12 is arranged to detect the portion of the electronic document 14 that is unrendered (this process is described in more detail below with reference to FIG. 2). Once the unrendered portion of the document 14 has been identified, then the receiving device 12 generates a feedback document 18, which comprises a portion of the original electronic document 14.

The feedback document 18 is then transmitted, which may be back to the source of the original document 14, or may be to a local storage device 20. The receiving device 12 is arranged to detect the source of the electronic document 14, and to transmit the feedback document 18 to the source of the electronic document 14, if that is desired.

The feedback document 18 comprises the portion of the electronic document 14 that is rendered. Therefore, the contents of the feedback document 18 are a subset of the original document 14, when not all of the original electronic document 14 is rendered. The exact same terms that are present in the document 14 being rendered are used in the feedback document 18. Should the set of devices 16 be able to render all of the renderable terms in the document 14, then a feedback document 18 will still be generated.

In the case of languages that are more complicated than HTML the feedback is especially valuable, particularly where the electronic document is being generated ‘on-the-fly’ by an application. Because the authoring process is abstracted from the rendering capabilities of the devices in the end user location it is highly probable that significant elements of an experience will not be rendered. In many applications it will be useful to know that this has happened, either to adjust expectations of reaction/interaction or in order to adjust the material delivered to better match the capabilities of the rendering system.

Likewise when authoring content the process of debugging is largely about understanding where the intention is not met by the result. By being able to return the representation of the result in the same terms as the original it makes it easier to see where problems may occur. In these complex experiential systems problems are often more subtle than pure syntactic or logical errors and this should be a useful tool in analysing these.

FIG. 2 illustrates in more detail, the steps taken by the receiving device 12 following receipt of the electronic document 14. The engine shown in this Figure is operating in a dynamic markup language system. The engine is a set of software modules that mediate between the intentions of the author, captured in raw descriptions (known as “fragments”), and the capabilities of the end users ‘browser’ which is defined by the type and location of enabled devices in their location.

The modules are:
Parser—takes the document in XML format and adds the fragments to the pool of current experiences.
Snapshot—selects those parts that are active at the current point in time
Can Do—generates a list of all possible actions that the current ‘browser’ could do to describe the experience
UN—resolves conflicts in the Can Do List, mediates multiple options and tries to achieve the best possible result—producing a Will Do List.
Make-it-so—Takes the resolved list and instructs the enabled devices.

A dynamic markup language is an approach that takes fragments of markup language from various sources into a ‘pool’. This raw markup language contains references both to time and logical conditionals. This ‘pool’ of fragments is then processed to create a snapshot based on the current context, which in itself is much more like a traditional markup language—being entirely declarative. This is what is then realised by the engine. The snapshot process is repeated as necessary to generate new snapshots as time passes and the context changes. This includes when adding new fragments, on removal of old material and at timed changes.

The Will-Do-List contains a set of instructions for the devices 16, but contained within this is also enough information to indicate which parts of the snapshot this refers to. Therefore it is possible to construct a representation of the rendered results from this, being the subset of the snapshot that achieves what is actually experienced by the end user. In an ideal world (or well defined system) the subset and the snapshot will be the same, indicating that the author's intention was fully realised.

In many situations this subset will not be the same as the snapshot, and this representation (the feedback document 18) can then be made available by the engine (via an API) to be queried by the author or from the source application. As the author will be aware of their intentions, comparison can be made, and if appropriate the source adjusted to try and achieve a better match.

This idea is particularly applicable in highly dynamic content such as games where the original game author cannot be certain of the browser capabilities of the end user. As scoring or experience delivery is often highly dependent on reacting to what the end user is seeing and doing it will be very valuable to understand how closely this matches what the source was delivering. So for example if the gamer did not shoot a monster then it is important to know whether this was because the user missed the monster or because the monster was never rendered in the first place.

For wider application, for example in room mood lighting, understanding the users experience should allow a lighting designer (or potentially automated tools) to improve a design for a particular situation. This can even be done remotely based on this feedback for example, in a shop or office environment. In content authoring the feedback can also be used to debug, highlighting when reality doesn't match the expectation of the author.

FIG. 3 shows an example of a location 22, seen from above. The location is split into nine logical sub-locations, with the points of the compass, North, North-East, East, South-East, South, South-West, West, and North-West and the central zone C. The location 22 contains two lamps, Lamp 1 in the logical sub-location NW and Lamp 2 in the logical sub-location NE. The location 22 will be used to illustrate two different examples of the operation of the data processing system 10, depending upon the contents of the received electronic document 14.

### EXAMPLE 1

In this example, the elements within the electronic document 14 are as follows:

<object> A

<location> NW </location>
<state> fire </state>
<start_time> 0:00 </start_time>
<end_time> forever </end_time>

</object>
<object> B

<location> NE </location>
<state> water </state>
<start_time> 0:00 </start_time>
<end_time> forever </end_time>

</object>
<asset> flames

<state> fire </state>
<type> light </type>
<value> 90, 20, 0 </value>

</asset>
<asset> wet

<state> water </state>
<type> light </light>
<value> 0, 20, 90 </value>

</asset>
<asset> purple_hit

<state> hit </state>
<type> light </light>
<value> 100, 0, 100 </value>

</asset>
<device> lamp1

<location> NW </location>
<capability> light </capability>

</device>
<device> lamp2

<location> NE </location>
<capability> light </light>

</device>

The elements within the document 14 are objects A and B, assets flames, wet and purple_hit and devices lamp1 and lamp2. In this case lamp1 will render object object A using the flame asset and object B will be rendered on lamp2 using the wet asset. So the contents of the returned feedback document 18 will be:

<object> A

<location> NW </location>
<state> fire </state>

</object>
<object> B

<location> NE </location>
<state> water </state>

</object>

Note that the time component is immaterial to this representation as the feedback document 18 is the status of the objects at the instant of rendering.

### EXAMPLE 2

In this example, it is assumed that the system time is 2:00. The contents of the received document 14 are as follows:

<object> A

<location> NW </location>
<state> fire </state>
<start_time> 0:00 </start_time>
<end_time> forever </end_time>

</object>
<object> B

<location> NE </location>
<state> water, smoke </state>
<start_time> 0:00 </start_time>
<end_time> forever </end_time>

</object>
<object> C
<location> NE </location>
<state> hit </state>
<start_time> 0:00 </start_time>
<end_time> forever </end_time>
</object>
<object> D

<location> NW </location>
<state> hit </state>
<start_time> 5:00 </start_time>
<end_time> forever </end_time>

</object>
<asset> flames

<state> fire </state>
<type> light </type>
<value> 90, 20, 0 </value>

</asset>
<asset> wet

<state> water </state>
<type> light </light>
<value> 0, 20, 90 </value>

</asset>
<asset> purple_hit

<state> hit </state>
<type> light </light>
<value> 100, 0, 100 </value>

</asset>
<device> lamp1

<location> NW </location>
<capability> light </capability>

</device>
<device> lamp2

<location> NE </location>
<capability> light </light>

</device>

In this example (compared to example 1) there are new objects C and D and an additional state in object B, being smoke. As in example 1, lamp1 will render object object A using the flame asset and object B will be rendered on lamp2 using the wet asset. The returned feedback document 18 will be, in this second example:

<object> A

<location> NW </location>
<state> fire </state>

</object>
<object> B

<location> NE </location>
<state> water </state>

</object>

Both A and B are rendered (on the lights) but as there is no way of rendering the smoke state of object B that state is not returned in the representation of that object as it was rendered. Object C is not returned because the engine has chosen object B to be rendered on the light on the NE so there is nothing to render it. Object D is not returned as it is not rendered as it is not within its start and end times.

It can be seen that the contents of the feedback document 18 reflect the rendering of the original document 14. The device or devices that receive the electronic document 14 will render the contents of that document 14 as best they are able, and the contents of the feedback document 18 reflect the rendering by the devices 16.

1-17. (canceled)

18. A data processing method comprising receiving an electronic document (14), rendering at least a portion of the electronic document (14), detecting the portion of the electronic document (14) that is unrendered, generating a feedback document (18) comprising a portion of the electronic document (14), and transmitting the feedback document (18), wherein the feedback document (18) comprises the portion of the electronic document (14) that is rendered and the step of rendering at least a portion of the electronic document (14) includes selecting elements from the electronic document (14) according to a dynamic variable.

19. A method according to claim 18, and further comprising detecting the source of the electronic document (14), and transmitting the feedback document (18) to the source of the electronic document (14).

20. A method according to claim 18, wherein the step of rendering at least a portion of the electronic document (14) comprises operating a set of devices (16) according to the electronic document (14).

21. A method according to claim 18, wherein the step of transmitting the feedback document (18) comprises storing the feedback document (18) in a local data storage device (20).

22. A data processing system comprising a receiving device (12) for receiving an electronic document (14), a set of devices (16) arranged to render at least a portion of the electronic document (14), the receiving device (12) arranged to detect the portion of the electronic document (14) that is unrendered, to generate a feedback document (18) comprising a portion of the electronic document (14), and to transmit the feedback document (18), wherein the feedback document (18) comprises the portion of the electronic document (14) that is rendered and the receiving device (12) is arranged to select elements for rendering, from the electronic document (14), according to a dynamic variable.

23. A system according to claim 22, wherein the receiving device (12) is further arranged to detect the source of the electronic document (14), and to transmit the feedback document (18) to the source of the electronic document (14).

24. A system according to claim 22, and further comprising a local storage device (20), the receiving device (12) arranged, when transmitting the feedback document (18), to store the feedback document (18) in the local data storage device (20).

25. A computer program product, on a computer readable medium, for operating a data processing system (10) comprising instructions for receiving an electronic document (14), rendering at least a portion of the electronic document (14), detecting the portion of the electronic document (14) that is unrendered, generating a feedback document (18) comprising a portion of the electronic document (14), and transmitting the feedback document (18), wherein the feedback document (18) comprises the portion of the electronic document (14) that is rendered and the instructions for the rendering at least a portion of the electronic document (14) includes instructions for selecting elements from the electronic document (14) according to a dynamic variable.

26. A computer program product according to claim 25, and further comprising instructions for detecting the source of the electronic document (14), and for transmitting the feedback document (18) to the source of the electronic document (14).

27. A computer program product according to claim 25, wherein the step of rendering at least a portion of the electronic document (14) comprises operating a set of devices (16) according to the electronic document (14).

28. A computer program product according to claim 25, wherein the step of transmitting the feedback document (18) comprises storing the feedback document (18) in a local data storage device (20).
